(19) United States
(12) Patent Application Publication
(10) Pub. No.: US 2006/0193715 A1
(43) Pub. Date: Aug. 31, 2006

(54) Tilt-lock mechanism for tilt-bed trailers

(76) Inventor: Steven Jude Harmon, Aurora, MO (US)

Correspondence Address: Steven J. Harmon, PO Box 913, Aurora, MO, 65605, US

(21) Appl. No.: 11/068,469

(22) Filed: Feb. 28, 2005

(51) Int. Cl. B60P 1/04

(52) U.S. Cl. 414/482

(57) ABSTRACT

The tilt-lock mechanism provides the stability to allow smooth loading and unloading of a motorcycle onto a tilt-bed trailer. The first step is to raise the bed to where the tilt-lock mechanism fully engages and allows the bed to remain in an inclined position. The user can then load the motorcycle up onto the bed of the trailer. The next step is when the front wheel of the motorcycle trips the tilt-release activator whereby the mechanism is released and the bed of the trailer begins its descent. In the final step, the main bed of the trailer gently eases into a level position so that it may be secured again to the tongue of the trailer with the latch pin.

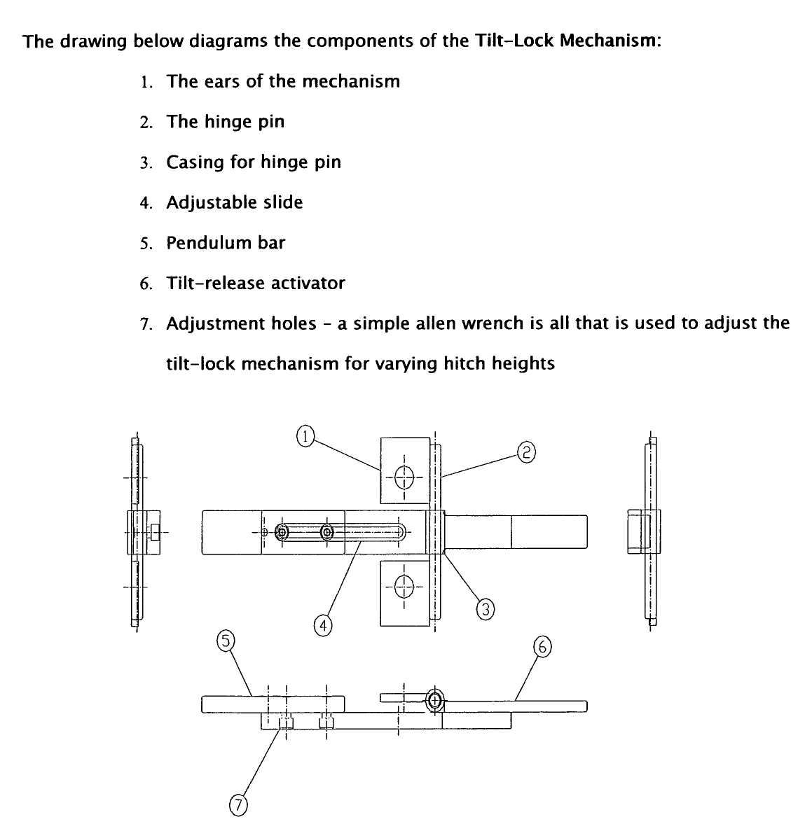

The invention relates to all types of tilt-bed trailers. This particular mechanism was designed for use with a motorcycle trailer. However, this same device could easily be manufactured in different sizes for use with all types and weights of trailers.

There are many tilt-bed trailers in production. The reason that trailers have been designed with tilting beds is to allow the user greater ease in loading and unloading vehicles on the trailer. The most common issue in the design of such trailers is the lack of a device that will stabilize the bed while it is in a tilted position during loading and unloading. In the case of a motorcycle trailer, for example: If a user loads a motorcycle onto a tilt- bed trailer, the user must first tilt the bed at an angle and then push the motorcycle onto the bed of the trailer. When the front wheel of the motorcycle reaches the tilt point of the trailer bed, the back wheel is still on the ground. This situation causes the trailer bed to flip up under the motorcycle and could cause damage from the trailer hitting the motorcycle. Another issue is that once the motorcycle is fully loaded, the trailer bed then slams uncontrolled to a level position. A common practice to remedy this situation is to have the user and other assistants stand on the back corners of the trailer bed during loading and unloading to stabilize the bed.

This invention is called a Tilt-Lock Mechanism. It is a device that attaches to the underside of the main pan of the trailer (in this case, a motorcycle trailer). The main bars of the tilt-lock mechanism are much like a teeter-totter. The center “ears” attach to the main bars with a hinge pin that is welded at the ends, but allows the “ears” to move freely. The Tilt-Lock Mechanism for this motorcycle trailer is installed in an oval cut-out of the channel of the trailer bed, allowing the main upper bar to rise through the trough as the bed is tilted.

The utilization of the Tilt-Lock Mechanism is unique in the market of tilt-bed trailers. The main bed of the trailer is attached to the tongue with a latch pin. The user removes the latch pin, then stands on the back of the trailer to tilt the bed. As the bed tilts, with the tail piece lowering to the ground, the tilt-lock mechanism rises up through an oblong channel that is cut out of the main bed. The upper end of the main bar is the tilt-release activator. The lower end of the main bar houses the adjustable slide (for adjusting the mechanism to different hitch heights). This end acts as a pendulum and falls down with gravity as the bed of the trailer is tilted. Once the bed is fully tilted, this lower bar rests onto the tongue of the trailer to stabilize the bed during loading and unloading. Once the motorcycle is loaded onto the bed of the trailer, the front wheel will trip the tilt-release activator, thus allowing the trailer bed to be lowered.

What is claimed is:

1. The tilt-lock mechanism. The tilt-lock mechanism is a unique new invention designed to solve a problem that is prevalent with many tilting trailers on the market. The tilt-bed trailers, while handy, lack a device to stabilize the bed of the trailer to the tongue so that loading and unloading can be done safely and with ease. The tilt-lock mechanism attaches to the bed of the trailer, with the adjustable lever visible through an open oblong channel in the bed. This invention can be manufactured for all sizes of trailers. However, the trailer beds would need to be designed to accommodate this device, so that there is an open channel for the tilt-lock activator to protrude through when the bed is tilted. The tilt-lock mechanism is equipped with an slide adjustment to allow for varying hitch heights.
